(19) United States
(12) Patent Application Publication
(10) Pub. No.: US 2015/0293056 A1
(43) Pub. Date: Oct. 15, 2015

(54) METHOD AND DEVICE FOR SENSING A LIQUID

(71) Applicant: KONINKLIJKE PHILIPS N.V., Eindhoven (NL)

(72) Inventors: Declan Patrick Kelly, Eindhoven (NL); Guangwei Wang, Eindhoven (NL)

(73) Assignee: KONINKLIJKE PHILIPS N.V., Eindhoven (NL)

(21) Appl. No.: 14/438,011

(22) PCT Filed: Sep. 12, 2013
(86) PCT No.: PCT/IB2013/058469

§ 371 Date: Apr. 23, 2015

(30) Foreign Application Priority Data
Oct. 25, 2012 (CN) PCT/CN2012/083487

(51) Int. Cl. G01N 27/447

(52) U.S. Cl. CPC G01N 27/447; G01N 27/44791

(57) ABSTRACT

The invention proposes a method and device for sensing a liquid that contains positively charged particles and/or negatively charged particles. An electrical field is imposed to the liquid by applying a voltage to a positive electrode and a negative electrode disposed in the liquid, for attracting the negatively charged particles toward the positive electrode to concentrate the negatively charged particles in a first part of the liquid and attracting the positively charged particles toward the negative electrode to concentrate the positively charged particles in a second part of the liquid. A first sensing result is obtained by sensing at least one part of liquid of the first part of the liquid, the second part of the liquid, and a third part of the liquid in which the negatively charged particles and the positively charged particles are deconcentrated. Accordingly, the sensing is conducted in at least one part of liquid in which the concentration of the charged particles is changed. Since the concentration of the particles in the liquid impacts the sensitivity of the sensing of the liquid, it is possible to improve the sensitivity.

### FIELD OF THE INVENTION

The present invention relates to liquid sensing, and particularly relates to a method and device for sensing a liquid.

### BACKGROUND OF THE INVENTION

Liquid sensing often aims to sense particles such as ions and molecules in liquids such as water and beverage for various purposes. For example, the target particles can be metallic ions such as Ca⁺⁺, Mg⁺⁺ related to water hardness, caffeine, protein, etc.

A typical problem with sensing of particles in a liquid is low sensitivity due to relatively low concentration of the target particles in the liquid or interference from other particles contained in the liquid.

### OBJECT AND SUMMARY OF THE INVENTION

Considering the problem mentioned above, it would be advantageous to improve the sensitivity of sensing a liquid.

In some cases, it is desirable to sense charged particles including positively charged particles and/or negatively charged particles. For example, the positively charged particles to be sensed could be metallic ions, caffeine, protein, amino acids, and the negatively charged particles could be Cl⁻, SO₄²⁻ and acetate. Thus, it would also be advantageous to improve the sensitivity of sensing charged particles in a liquid.

In some cases, it is desirable to sense non-charged particles. For example, non-charged particles to be sensed could be ethanol in alcohol, glycerin in cosmetic liquid, and ethyl acetate in food grade additives. The sensing of non-charged particles may be interfered by charged particles in the liquid. Thus, it would be also be advantageous to reduce or eliminate the interference from charged particles when sensing non-charged particles so as to improve the sensitivity.

In a first aspect of the invention, a method for sensing a liquid that contains positively charged particles and/or negatively charged particles is provided. The method comprises steps of:
imposing an electrical field to the liquid by applying a voltage to a positive electrode and a negative electrode disposed in the liquid, for attracting the negatively charged particles toward the positive electrode to concentrate the negatively charged particles in a first part of the liquid and attracting the positively charged particles toward the negative electrode to concentrate the positively charged particles in a second part of the liquid; and
obtaining a first sensing result by sensing at least one part of liquid of the first part of the liquid, the second part of the liquid, and a third part of the liquid in which the negatively charged particles and the positively charged particles are deconcentrated;

The imposed electrical field changes the concentration of the charged particles in the first, second and third part of the liquid and at least one of them is sensed. That is, the sensing is conducted in at least one part of liquid in which the concentration of the charged particles is changed. Since the concentration of the particles in the liquid impacts the sensitivity of the sensing of the liquid, it is possible to improve the sensitivity.

Furthermore, the electrical field is imposed using a positive electrode and a negative electrode. Therefore, the change of the concentration of the particles in the liquid is achieved without high extra cost or increased sensing complexity.

The sensing can be made using any sensor sensing liquid properties based on various sensing methods, including but not limited to Electrical conductivity, Electromagnetic radiation, Refractometry, Ultrasound and Electrochemistry.

The liquid can be water, beverage, coffee, soja milk, etc.

One aim of sensing a liquid can be detecting target particles. In an embodiment, the method further comprises detecting target particles on the basis of the first sensing result.

The detecting results can be either qualitative or quantitive. In an embodiment, detecting target particles comprises detecting whether the target particles exist in the liquid.

In another embodiment, detecting target particles comprises determining the amount of the target particles. For example, a measure of the amount of the target particles can be the concentration or absorbance of the target particles in the liquid.

The target particles can be charged particles or non-charged particles. The at least one part of liquid can be selected from the first, second and third part of the liquid according to various factors such as the properties of the target particles, the concentration of the target particles and/or the sensing manner.

In an embodiment, the at least one part of liquid comprises the first part of the liquid, if the target particles are negatively charged; the at least one part of liquid comprises the second part of the liquid, if the target particles are positively charged; and the at least one part of liquid comprises the third part of the liquid, if the target particles are non-charged.

In this manner, in case that the target particles are charged, the sensing is made in the part of the liquid in which the target particles are concentrated. Thus, the sensitivity can be improved due to the higher concentration of the target particles. In case that the target particles are non-charged, the sensing is made in the third part of the liquid in which the charged particles as interfering particles are deconcentrated. Thus, the sensitivity can be improved due to the less interference from the charged particles.

In an embodiment, the at least one part of liquid comprises the first part and the second part of the liquid, if the target particles are negatively or positively charged.

Sensing both the part of the liquid in which the target particles are concentrated and the part of the liquid in which the target particles are deconcentrated are referred to as double-sided sensing hereinafter.

An advantage of double-sided sensing is that and the relatively results can be used to determine the original concentration in the liquid.

Furthermore, double-side sensing has a further advantage. When a non-selective sensor is used, the relative sensing results from the two parts can be used to give a selective result. Since the only difference between the two parts is the relative concentrations of the charged particles, the difference in the sensing results directly reflects this. When the liquid is known to be dominated by a number of charged particles, the result of a non-selective sensor gives the relative amounts of the charged particles.

In an embodiment, the at least one part of liquid comprises the second part or the third part of the liquid, if the target particles are negatively charged; and the at least one part of liquid comprises the first part or the third part of the liquid, if the target particles are positively charged.

In this manner, the sensing is made in the part of the liquid in which the target particles are deconcentrated. In some cases, the sensing may be inaccurate because the original concentration of the target particles is too high for the used sensor, namely that the sensor gives its maximum reading. In these cases, it would be advantageous to sense the part of the liquid in which the target particles are deconcentrated so as to obtain an accurate reading of the sensor and achieve an improved sensitivity.

In an embodiment, the method further comprises a step of obtaining a second sensing result by sensing the liquid when the electrical field is not imposed; and the step of detecting comprises detecting the target particles on the basis of the first sensing result and the second sensing results.

In this manner, the sensing is made before and after concentrating the charged particles through the electrical field to obtain respective sensing results. Since the difference between the first sensing result and the second sensing result is only caused by the electrical concentration, the sensitivity can be improved by combining the two sensing results.

In an embodiment, the voltage is adjusted on the basis of at least one of a weight of the charged particles and a charge amount of the charged particles. For example, heavier particles require higher voltage. For another example, more charge, less voltage is required.

In this manner, the charged particles can be effectively concentrated by using a proper voltage. Furthermore, the voltage can be adjusted to selectively sense particles of different weight and charge amount.

Additionally, it is noted that it is unnecessary to know the absolute weight of the particles, and a relative value would be sufficient. For example, assuming that a given voltage is known to be proper for a charged particle, the voltage can be increased for another charged particle which carries the same amount of charges but is heavier than the charged particle.

In an embodiment, multiple voltages are subsequently applied, and the first sensing result comprises multiple measurements, each of which corresponds to one of the multiple voltages.

In an example, step-wise increased voltage is applied and sensing is made in each step. This enables the possibility of differentiation among charged particles having the same polarity but different mass or different amount of charge.

In another example, continuously increased voltage is applied and continuous sensing is made. Once the reading of the sensor saturates at a certain value, the corresponding voltage can indicate the concentration of the target particles in the liquid.

In an embodiment, the step of sensing comprising: collecting one of the at least one of the first part, the second part and the third of the liquid in a chamber; and sensing the collected part of the liquid in the chamber.

Since the respective part of the liquid is collected before being sensed, it is unnecessary to make the sensing while concentrating the charge particles using electrical field simultaneously. Thus, the electrical field is unnecessary to be applied when the sensing is made. This is particularly advantageous for sensing based on electrical methods such as electrical conductivity and electrochemistry, because the sensing results of electrical methods may be interfered by the electrical field used to concentrate the charged particles.

As noted, in some cases, it is possible to calibrate and overcome such interference. Thus, electrical method can be used without collecting the respective part of the liquid before making the sensing.

In a second aspect of the invention, a device for sensing a liquid that contains positively charged particles and/or negatively charged particles is provided. The device comprises:
a chamber for containing the liquid;
a positive electrode and a negative electrode disposed in the liquid and configured to impose an electrical field to the liquid for attracting the negatively charged particles toward the positive electrode to concentrate the negatively charged particles in a first part of the liquid and attracting the positively charged particles toward the negative electrode to concentrate the positively charged particles in a second part of the liquid when a voltage is applied to the positive electrode and the negative electrode;
a power supply coupled to the positive electrode and the negative electrode and configured to apply the voltage thereto; and
a sensing unit configured to obtain a first sensing result by sensing at least one part of liquid of the first part of the liquid, the second part of the liquid, and a third part of the liquid in which the negatively charged particles and the positively charged particles are deconcentrated.

In an embodiment, the sensor unit can comprises one or more sensors. In an example, the sensor can be selective sensor. In another example, the sensor can be non-selective sensor.

In an embodiment, the positive electrode and the negative electrode are spaced apart from each other to split the liquid into the first part of the liquid adjacent to the positive electrode, the second part of the liquid adjacent to the negative electrode, and the third part of the liquid in the middle of the positive electrode and the negative electrode.

In an embodiment, the device further comprises a collecting unit for collecting one of the at least one of the first part, the second part and the third part of the liquid in a separate chamber for being sensed.

In an embodiment, the device comprises at least one of a first channel, a second channel and a third channel, wherein the chamber has an inlet for receiving the liquid, at least one of a first outlet disposed adjacent to the positive electrode, a second outlet disposed adjacent to the negative electrode and a third outlet disposed in the middle of the positive electrode and the negative electrode; the first channel is in fluid communication with the first outlet; the second channel is in fluid communication with the second outlet; and the third channel is in fluid communication with the third outlet.

In this manner, the first part, the second part and the third part of the liquid are respectively passed through the first channel, the second channel and the third channel. Thus, the respective part of the liquid can be separately sensed or collected. In an example, the liquid in the three channels may be re-converged in one stream at the exit of the channels.

The terms “chamber” and “channel” as used herein are to be interpreted in a broad sense. Thus, the terms are meant to include cavities or conduits of any desired shape or configuration through which liquids may be held or directed. For example, such a fluid cavity may comprise a flow-through cell where fluid is to be continually passed or, alternatively, a chamber for holding a specified, discrete amount of fluid for a specified amount for time.

In an embodiment, the chamber, the first channel, the second channel, and the third channel are micro fluidic.

Accordingly, only a small sample of liquid is necessary. Moreover, the sensor as well as the electrodes can be of a small size, resulting in a very low extra cost.

The term “microfluidic” as used herein to be understood, without any restriction thereto, to refer to structures or devices through which fluid(s) are capable of being passed, directed, mixed, separated or otherwise processed, wherein micro fluidic structures or devices are geometrically constrained to a small, typically submillimeter, scale. For example, one or more of the dimensions can be typically less than 500 microns.

In an embodiment, the chamber, the first channel, the second channel, and the third channel are surface micromachined.

### BRIEF DESCRIPTION OF THE DRAWINGS

The above and other objects and features of the present invention will become more apparent from the following detailed description considered in connection with the accompanying drawings, in which:

FIG. 1 shows an exemplary device for sensing a liquid according to an embodiment of the invention;

FIG. 2 shows the experimental result for sensing a liquid using the device of FIG. 1;

FIG. 3 shows an exemplary device for sensing a liquid according to an embodiment of the invention; and

FIG. 4 shows the experimental result for sensing a liquid using the device of FIG. 3; and

FIG. 5 shows the experimental result for sensing a liquid according to an embodiment of the invention.

### DETAILED DESCRIPTION

Reference will now be made to embodiments of the invention, one or more examples of which are illustrated in the figures. The embodiments are provided by way of explanation of the invention, and are not meant as a limitation of the invention. For example, features illustrated or described as part of one embodiment may be used with another embodiment to yield still a further embodiment. It is intended that the invention encompass these and other modifications and variations as come within the scope and spirit of the invention.

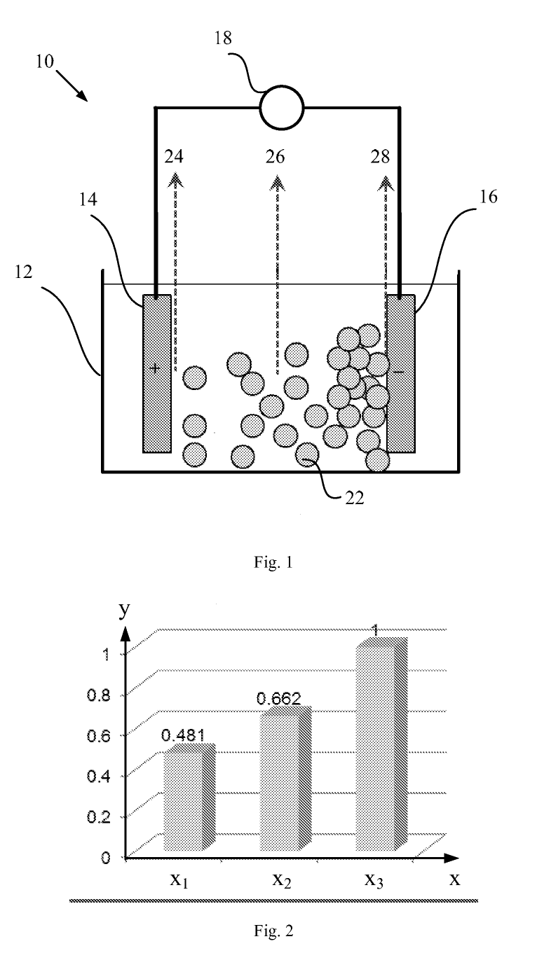

FIG. 1 shows an exemplary device for sensing a liquid according to one embodiment of the invention.

Referring to FIG. 1, the device 10 comprises a chamber 12, a positive electrode (i.e. anode) 14, a negative electrode (i.e. cathode) 16, a power supply 18, and a sensing unit (not shown).

The chamber 12 is used to contain a liquid to be sensed. The positive electrode 14 and the negative electrode 16 are disposed in the chamber 12 to be immersed in the liquid and spaced apart from each other. The power supply 18 may be a DC power supply capable of providing a given voltage.

When the power supply 18 provides a given voltage on the positive electrode 14 and the negative electrode 16, an electrical field is generated and imposed to the liquid contained by the chamber. Under the electrical field, negatively charged particles in the liquid (if exist) are attracted toward the positive electrode so as to be concentrated in the part of the liquid adjacent to the positive electrode. Furthermore, the farther the part of the liquid is away from the positive electrode, the lower the concentration of the negatively charged particles is. Similarly, under the electrical field, positively charged particles in the liquid (if exist) are attracted toward the negative electrode so as to be concentrated in a second part of the liquid adjacent to the positive electrode.

An experiment is made to show the concentration of the charged particles under the electrical field using the device 10. In this experiment, the chamber 12 is filled with a 300 ml, methylene blue aqueous solution whose absorbance is 2.34 μM, and a voltage of 60 V is applied to the electrodes. Since the methylene blue (illustrated in FIG. 1 as circles 22) bears positive charge after dissolving in water, it is expected to be attracted toward the cathode 16. after 60 min, solution samples are taken from the part of the solution adjacent to the positive electrode (referred to as anode area hereinafter), the part of the solution in the middle of the electrodes (referred to as middle area hereinafter), and the part of the solution adjacent to the negative electrode (referred to as cathode area hereinafter), and then sensed, as respectively depicted in the three dashed arrow lines 24, 26 and 28. The absorbance of each of these samples is recorded in Table 1, and the normalized absorbance is shown in FIG. 2. Referring to FIG. 2, the x-axis is the index of the samples, x₁, x₂, x₃ referring to the samples taken from anode area, middle area, and cathode area, respectively; the y-axis is the normalized absorbance of these samples. As it can be seen from Table 1 and/or FIG. 2, the absorbance in the cathode area is the highest, and the absorbance in the anode area is the lowest, which evidences that the positively charged methylene blue particles are attracted toward the cathode and concentrated in the cathode area.

TABLE 1

| | Absorbance (a.u.) | Concentration (μM) |
|---|---|---|
| Anode area | 0.037 | 1.57 |
| Middle area | 0.051 | 2.17 |
| Cathode area | 0.077 | 3.28 |

The time required for the charged particles to be attracted to the corresponding electrode depends on the applied voltage as well as the distance between the electrodes. Practically, a much smaller channel (e.g. 200 micrometer) would be suitable for sensing application, and the required time would be also much shorter, as described in below.

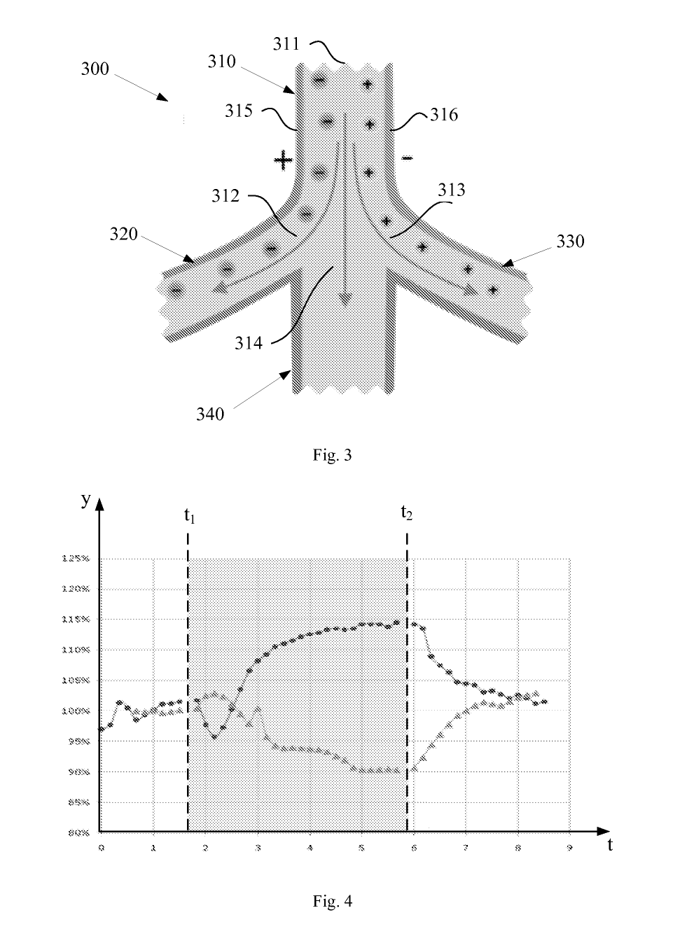

FIG. 3 shows an exemplary device for sensing a liquid according to an embodiment of the invention.

Referring to FIG. 3, the device 300 comprises a chamber 310, a positive electrode 315 and a negative electrode 316 disposed at the two opposite side surfaces of the chamber 310. In an example, the two opposite side surfaces of the chamber 310 can be made of conductive materials so as to be directly served as the electrodes.

Further referring to FIG. 3, the device 300 further comprises a first channel 320, a second channel 330 and a third channel 340. The chamber 310 has an inlet 311 for receiving the liquid, at least one of a first outlet 312 disposed adjacent to the positive electrode 315, a second outlet 313 disposed adjacent to the negative electrode 316 and a third outlet 314 disposed in the middle of the two electrodes 315, 316. The first channel 320, the second channel 330 and the third channel 340 are respectively in fluid communication with the first outlet 312, the second outlet 313 and the third outlet 314.

When a liquid flows into the chamber 310, it is split into three streams which respectively pass through the three channels 320, 330, 340, as indicated by the three arrows in FIG. 2.

When a voltage is applied to the electrodes 315, 316, the negatively charged particles in the liquid are to be attracted toward the side of the positive electrode 315, and the positively charged particles in the liquid are to be attracted toward the side negative electrode 316. Thus, the stream passing through the first channel 320 is expected to have enriched negatively charged particles, the stream passing through the second channel 330 is expected to have enriched positively charged particles, and the stream passing through the third channel 340 is expected to be without significant number of charged particles, as illustrated in FIG. 3.

An experiment is made to show the concentration of the charged particles under the electrical field using the device 300. In this experiment, the chamber 310 has a channel width of 200 nm. A NaCl solution with 10 μS/cm NaCl electrolyte flows into the chamber 310 at a rate of 1 mL/min. A voltage of 2.0 V is applied to the electrodes to generate an electrical field. In this experiment, the streams from the first channel 320 and the second channel 330 are converged (not shown) and referred to as waste output, and the stream from the third channel 340 is referred to as main output.

In this experiment, the ions in the waste output and in the main output are respectively counted, and recorded in the FIG. 4. Referring to FIG. 4, the x-axis is the time in unit of minutes, and the y-axis is the ion count. The curve with dots represents the ion count in the waste output, and the curve with triangles represents the ion count in the main output. Time t₁ is the time when the electrical field is switched on, and time t₂ is the time when the electrical field is switched off. As shown in FIG. 4, when the electrical field is on (i.e. a voltage of 2.0 V is applied to the electrodes), the ion count in the waste output is significantly higher than that in the main output. When the electrical field is off (i.e. no voltage is applied to the electrodes), the ion count in the waste output is substantially same as that in the main output. This evidences that the ions including Na⁺ and Cl⁻ in the liquid are attracted toward the electrodes and concentrated in the streams passing through the first and second channel when the electrical field is imposed to the liquid. Furthermore, as seen in FIG. 4, the time required for the charged particles to be concentrated is only one or two minutes, which is acceptable in the sensing applications.

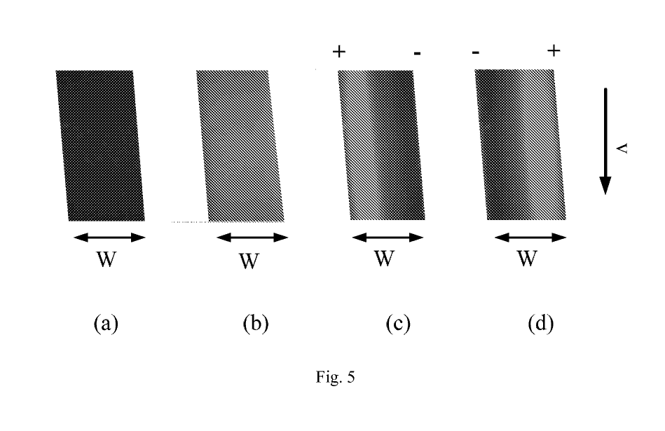

FIG. 5 shows the experimental result for sensing a liquid according to an embodiment of the invention. In this experiment, firstly, pure water flows into a channel having a width W of 80 micron at a rate v of 100 μL/min and a photo (as shown in FIG. 5(a)) of the channel is taken. Next, water with fluorescent anionic tracer flows into the same channel at the same rate and photos of the channel are taken in three different scenarios. In the first scenario, no electrical field is imposed, and the corresponding photo is shown in FIG. 5(b). In the second scenario, the opposite side surfaces of the channel are served as the electrodes and a voltage of 2 V is applied with the left side being the positive electrode and the right side being the negative electrode, and the corresponding photo is shown in FIG. 5(c). In the third scenario, a voltage of −2V is applied with the left side being the negative electrode and the right side being the positive electrode, and the corresponding photo is shown in FIG. 5(d).

It is known that the brightness of the photo indicates the concentration of the fluorescent anionic tracer, namely that the higher is the concentration in an area, the brighter the area is. As expected, the photo of the pure water is very dark (see FIG. 5(a)) because it contains no fluorescent anionic tracer, and the photo of the water with fluorescent anionic tracer in the scenario that no electrical field is imposed is uniformly bright (see FIG. 5(b)) because the fluorescent anionic tracer is supposed to be uniformly distributed in the water without any electrical field. As seen from FIGS. 5(c) and (d), the area at the side of the positive electrode is brighter, which indicates that the fluorescent anionic tracer is attracted towards the positive electrode.

It should be noted that the above described embodiments are given for describing rather than limiting the invention, and it is to be understood that modifications and variations may be resorted to without departing from the spirit and scope of the invention as those skilled in the art readily understand. Such modifications and variations are considered to be within the scope of the invention and the appended claims. The protection scope of the invention is defined by the accompanying claims. In addition, any of the reference numerals in the claims should not be interpreted as a limitation to the claims. Use of the verb “comprise” and its conjugations does not exclude the presence of elements or steps other than those stated in a claim. The indefinite article “a” or “an” preceding an element or step does not exclude the presence of a plurality of such elements or steps.

1. A method for sensing a liquid that contains positively charged particles and/or negatively charged particles, the method comprising steps of:
imposing an electrical field to the liquid by applying a voltage to a positive electrode and a negative electrode disposed in the liquid, for attracting the negatively charged particles toward the positive electrode to concentrate the negatively charged particles in a first part of the liquid and attracting the positively charged particles toward the negative electrode to concentrate the positively charged particles in a second part of the liquid; and
obtaining a first sensing result by sensing at least one part of liquid of the first part of the liquid, the second part of the liquid, and a third part of the liquid in which the negatively charged particles and the positively charged particles are deconcentrated.

2. The method of claim 1, further comprising detecting target particles on the basis of the first sensing result.

3. The method of claim 2, wherein
the at least one part of liquid comprises the first part of the liquid, if the target particles are negatively charged;
the at least one part of liquid comprises the second part of the liquid, if the target particles are positively charged; and
the at least one part of liquid comprises the third part of the liquid, if the target particles are non-charged.

4. The method of claim 2, wherein the at least one part of liquid comprises the first part and the second part of the liquid, if the target particles are negatively or positively charged.

5. The method of claim 2, wherein
the at least one part of liquid comprises the second part or the third part of the liquid, if the target particles are negatively charged; and
the at least one part of liquid comprises the first part or the third part of the liquid, if the target particles are positively charged.

6. The method of claim 2, wherein:
the method further comprises a step of obtaining a second sensing result by sensing the liquid when the electrical field is not imposed; and
the step of detecting comprises detecting the target particles on the basis of the first sensing result and the second sensing results.

7. The method of claim 1, wherein the voltage is adjusted on the basis of at least one of a weight of the charged particles and a charge amount of the charged particles.

8. The method of claim 1, wherein multiple voltages are subsequently applied, and the first sensing result comprises multiple measurements, each of which corresponds to one of the multiple voltages.

9. The method of claim 1, wherein the step of sensing comprising:
collecting one of the at least one of the first part, the second part and the third part of the liquid in a chamber; and
sensing the collected part of the liquid in the chamber.

10. A device for sensing a liquid that contains positively charged particles and/or negatively charged particles, the device comprising:
a chamber for containing the liquid;
a positive electrode and a negative electrode disposed in the liquid and configured to impose an electrical field to the liquid for attracting the negatively charged particles toward the positive electrode to concentrate the negatively charged particles in a first part of the liquid and attracting the positively charged particles toward the negative electrode to concentrate the positively charged particles in a second part of the liquid when a voltage is applied to the positive electrode and the negative electrode;
a power supply coupled to the positive electrode and the negative electrode and configured to apply the voltage thereto; and
a sensing unit configured to obtain a first sensing result by sensing at least one part of liquid of the first part of the liquid, the second part of the liquid, and a third part of the liquid in which the negatively charged particles and the positively charged particles are deconcentrated.

11. The device of claim 10, wherein the positive electrode and the negative electrode are spaced apart from each other to split the liquid into the first part of the liquid adjacent to the positive electrode, the second part of the liquid adjacent to the negative electrode, and the third part of the liquid in the middle of the positive electrode and the negative electrode.

12. The device of claim 10, wherein the sensing unit comprises a sensor which is non-selective sensor.

13. The device of claim 10, further comprising a collecting unit for collecting one of the at least one of the first part, the second part and the third part of the liquid in a separate chamber for being sensed.

14. The device of claim 10, further comprising at least one of a first channel, a second channel and a third channel, wherein
the chamber has an inlet for receiving the liquid, at least one of a first outlet disposed adjacent to the positive electrode, a second outlet disposed adjacent to the negative electrode and a third outlet disposed in the middle of the positive electrode and the negative electrode;
the first channel is in fluid communication with the first outlet;
the second channel is in fluid communication with the second outlet; and
the third channel is in fluid communication with the third outlet.

15. The device of claim 14, wherein the chamber, the first channel, the second channel, and the third channel are microfluidic.
